(19) United States
(12) Patent Application Publication
(10) Pub. No.: US 2016/0138734 A1
(43) Pub. Date: May 19, 2016

(54) SUPPORT SYSTEM PROVIDING PRECISION STAND-OFF ADJUSTMENT FOR ELONGATED STRUCTURES

(71) Applicant: Derrick M. Keller, East Bernard, TX (US)

(72) Inventor: Derrick M. Keller, East Bernard, TX (US)

(21) Appl. No.: 14/542,559

(22) Filed: Nov. 15, 2014

(51) Int. Cl. F16L 3/26

(52) U.S. Cl. CPC F16L 3/26

(57) ABSTRACT

A support apparatus for an elongated structure includes a pipe flange and a base. The pipe flange has a pipe engaging structure and a base engaging structure attached to pipe engaging structure. The base has a pipe flange engaging structure and a support surface engaging structure attached to the pipe flange engaging structure. The pipe flange engaging structure is translatably engaged with the base engaging structure for allowing a distance between the support surface engaging structure and the pipe engaging structure to be selectively adjustable. A fastening arrangement is provided between the pipe flange and the base for enabling translation of the base with respect to the pipe flange to be selectively inhibited. The pipe flange is preferably made from a metal having a first material composition and the base is made from a metal having a second material composition different than the first material composition.

### FIELD OF THE DISCLOSURE

The disclosures made herein relate generally to support systems for pipes and the like and, more particularly, to a pipe support system that provides precision stand-off adjustment for elongated structures.

### BACKGROUND

Elongated structures such as pipes in piperacks and other types of structures (e.g., rods, tubes, ducts, etc) are used in many types of installations in various industries and applications (e.g., chemical and petroleum industry). Process pipe, drain lines and flare lines in refinery applications are examples of such an application and industry. These elongated structures may require some type of support along their length. These supports are commonly referred to as pipe shoes. The purpose of this support is to prevent damage due to stress and strain associated with process conditions in an elongated structure, to retain an as-installed position of an elongated structure, to limit unrestricted movement of the elongated structures and the like. In order to make the elongated structures and the supports (i.e., pipe shoes) meet, shims are often required.

Various types of supports for elongated structures are well known (e.g., non-adjustable pipe shoes). However these known support have one or more deficiencies that limit their ability to provide for precision stand-off adjustment. Most types of known supports offer no vertical adjustment. Other ones of these known supports offer only incremental vertical adjustments (i.e., by pre-set increments). Still further, known supports are not specifically configured based upon material properties for retaining structural integrity between engaged portions of the elongated structure and the support they are adjoined to by a welded interface.

Therefore, a support system that overcomes drawbacks associated with conventional supports by providing precision stand-off adjustment (e.g., continuous over a preset range of adjustment) and dissimilar material applicability would be advantageous, desirable and useful.

### SUMMARY OF THE DISCLOSURE

Embodiments of the present invention are directed to adjustable support systems for elongated structures such as, for example, pipes, tubes ducts and the like. More specifically, such embodiments of the present invention are directed to support systems that provide for precision stand-off adjustment and that are specifically configured based upon material properties for retaining structural integrity of engaged portions of the elongated structure and the support. In this regard, embodiments of the present invention overcome drawbacks associated with conventional non-adjustable support systems such as by engagement of an elongated structure with a support apparatus without having to use shims and providing for cost efficient and performance effective use with elongated structures made from materials having specialized welded interface requirements.

In one embodiment of the present invention, a support apparatus for an elongated structure comprises a pipe flange and a base. The pipe flange has a pipe engaging structure and a base engaging structure attached to pipe engaging structure. The base has a pipe flange engaging structure and a support surface engaging structure attached to the pipe flange engaging structure. The pipe flange engaging structure is translatably engaged with the base engaging structure for allowing a distance between the support surface engaging structure and the pipe engaging structure to be selectively adjustable.

In another embodiment of the present invention, a support apparatus for an elongated structure comprises a pipe flange, a base and a plurality of threaded fastener. The pipe flange has a pipe engaging structure and a base engaging structure attached to the pipe engaging structure. At least a portion of the pipe engaging structure is made from a metal having a first material composition. A first plurality of passages extends through the base engaging structure. The base has a pipe flange engaging structure and a support surface engaging structure attached to the pipe flange engaging structure. The pipe flange engaging structure is slideably engaged with the base engaging structure in a manner allowing the pipe flange to translate with respect to the pipe flange engaging structure. A second plurality of passages extend through the pipe flange engaging structure. Two or more of the passages of the second plurality of passages are each aligned with a respective passage of the first plurality of passages thereby defining a plurality of sets of aligned passages. The pipe flange engaging structure and the support surface engaging structure are each made from a material having a second material composition different than the first material composition; The plurality of threaded fastener are each engaged within a respective one of the two or more of the sets of aligned passages for enabling translation of the pipe flange engaging structure with respect to the base engaging structure to be selectively inhibited through tightening of each one of the threaded fasteners for causing the base engaging structure to become urged into contact with the pipe flange engaging structure.

In another embodiment of the present invention, a method comprises a plurality of operations. An operation is performed for installing at least a portion of a structural assembly including a plurality of lengths of elongated structures that are connected in an end-to-end fashion. The exterior wall of each one of the elongated structures is made from a metallic material having a first material composition. An operation is performed for providing a support assembly including a base and a pipe flange. The base is translatably engaged with the pipe flange for allowing a distance between the base and the pipe flange to be selectively adjustable. The pipe flange is made from a metallic material having that first material composition and the base is made from a metallic material having a second material composition. An operation is performed for engaging the pipe flange with the exterior wall of a particular one of the elongated structures followed by an operation being performed for applying at least one bead of weld material between the pipe flange and the exterior wall of the particular one of the elongated structures. Thereafter, an operation is performed for translating the base into contact with a support surface adjacent to the particular one of the elongated structures. While the base is in contact with the support surface, an operation is performed for fixedly securing the base to the pipe flange for inhibiting translation of the pipe flange with respect to the base such that the distance between the pipe flange with respect to the base is fixed.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a side view showing a support apparatus configured in accordance with a first embodiment of the present invention.

FIG. 2 is a cross-sectional view taken along the line 2-2 in FIG. 1.

FIG. 3 is a side view showing a support apparatus configured in accordance with a second embodiment of the present invention.

FIG. 4 is a cross-sectional view taken along the line 4-4 in FIG. 3.

FIG. 5 is a cross-sectional view showing a support apparatus configured in accordance with a third embodiment of the present invention.

### DETAILED DESCRIPTION

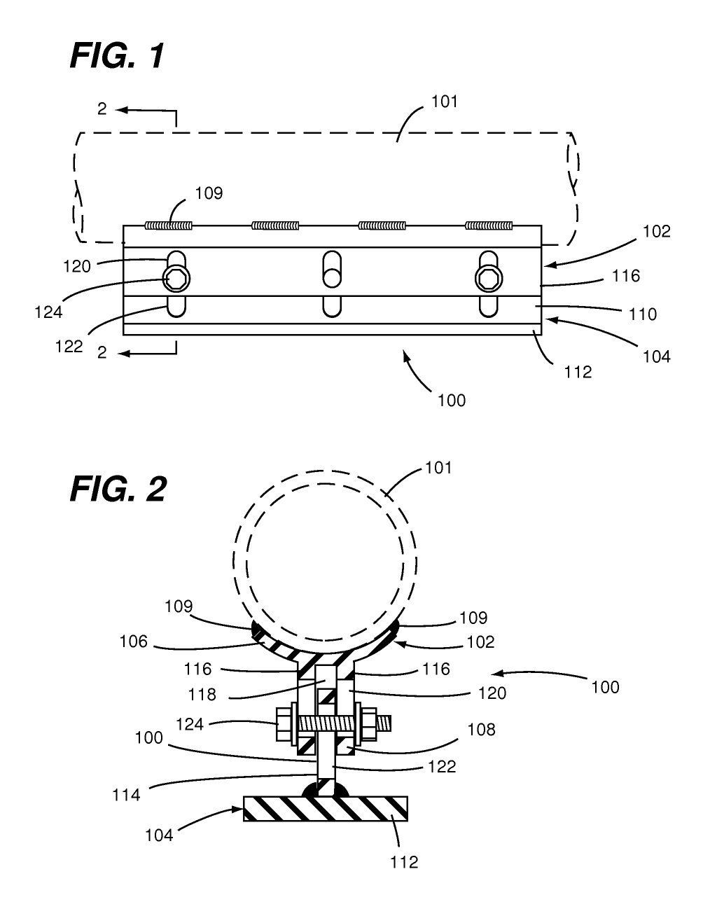

FIGS. 1 and 2 show a support apparatus 100 configured in accordance with a first embodiment of the present invention. The support apparatus 100 is used for supporting a structural assembly 101. A plurality of lengths of pipes, tubes or the like (i.e., elongated structures) that are connected in an end-to-end fashion is an example of the structural assembly. Similarly, the support apparatus 100 can also be used for supporting a single elongated structure.

The support apparatus 100 includes a pipe flange 102 and a base 104. The pipe flange 102 has a pipe engaging structure 106 and a base engaging structure 108 attached to pipe engaging structure 106. As shown, the pipe engaging structure 106 can be in the form of a saddle that engages a mating curvature of the structural assembly 101. Furthermore, it is disclosed herein that the pipe engaging structure 106 (i.e., pipe engaging portion of the support apparatus) can be a discrete structural component such as being a structural member that is detachable attached to the base engaging structure 108 such as via a channel arrangement (e.g., T-shaped or dovetail channel), threaded fasteners, or the like. As will be discussed below in greater detail, the pipe engaging structure 106 (and thus the pipe flange 102) can be configured for being welded to the structural assembly 101 by application of one or more beads 109 of weld material.

The base 104 has a pipe flange engaging structure 110 and a support surface engaging structure 112 attached to the pipe flange engaging structure 110. As depicted, the pipe flange engaging structure 110 of the base 104 includes an elongated beam 114 and the base engaging structure 108 of the pipe flange 102 includes spaced apart elongated beams 116 defining a channel 118 therebetween. The elongated beam 114 is slideably disposed within the channel 118. In this regard, the pipe flange engaging structure 110 is translatably engaged with the base engaging structure 108 (i.e., the pipe flange 102 is translatably engaged with the base 104) for allowing a distance between the support surface engaging structure 112 and the pipe engaging structure 106 to be selectively adjusted.

A mechanical fastening arrangement is provided jointly between the base engaging structure 108 and the pipe flange engaging structure 110. The mechanical fastening arrangement enables translation of the pipe flange 102 with respect to the base 104 to be selectively inhibited. In one specific embodiment, as shown in FIGS. 1 and 2, the mechanical fastening arrangement includes a first plurality of passages (i.e., base engaging structure passages 120) extending through the base engaging structure 108 and a second plurality of passages (i.e., pipe flange engaging structure passages 122) extending through the pipe flange engaging structure 110. Each one of the base engaging structure passages 120 are aligned with a respective one of the pipe flange engaging structure passages 122 thereby defining a plurality of sets of aligned passages. Preferably, but not necessarily, the passages of each one of the sets of aligned passages are slotted. A threaded fastener 124 (e.g., bolt with washers and nut) is engaged within two or more of the sets of aligned passages for enabling translation of the pipe flange engaging structure 110 with respect to the base engaging structure 108 to be selectively inhibited through tightening of the threaded fastener for causing the base engaging structure 108 to become urged into contact with the pipe flange engaging structure 110.

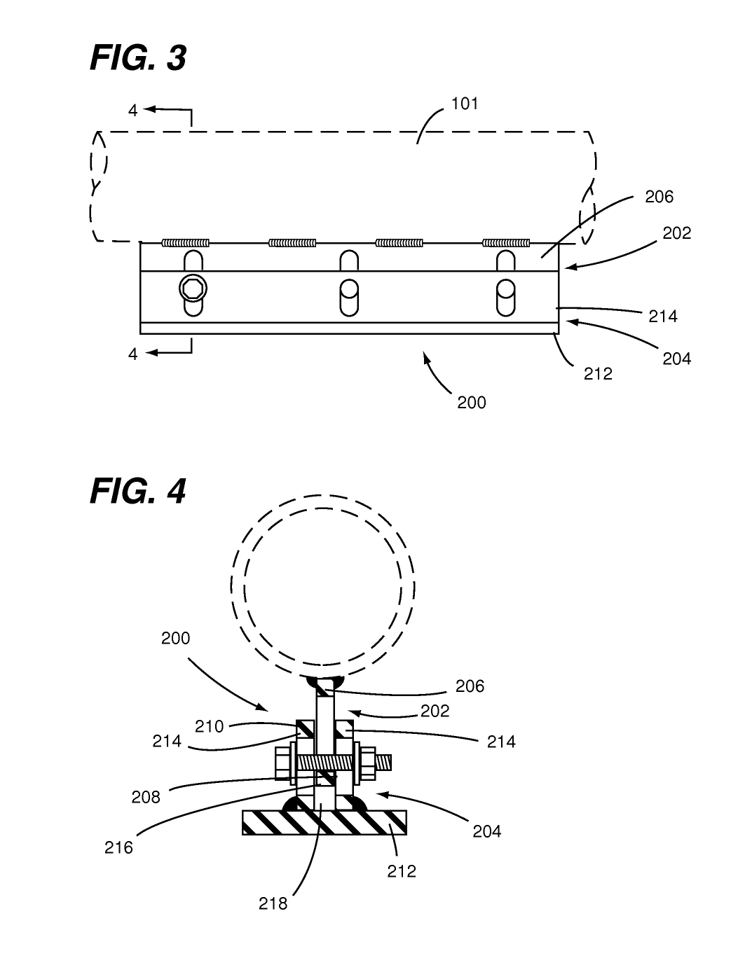

FIGS. 3 and 4 show a support apparatus 200 configured in accordance with a second embodiment of the present invention. The support apparatus 200 is used for supporting a structural assembly 201. The support apparatus 200 is similar in construction to the support apparatus 100 discussed above, except with the following noted differences with respect to the support apparatus 100. The support apparatus 200 includes a pipe flange 202 and a base 204. The pipe flange 202 has a pipe engaging structure 206 and a base engaging structure 208 attached to pipe engaging structure 206. As will be discussed below in greater detail, the pipe engaging structure 206 (and thus the pipe flange 202) can be configured for being welded to the structural assembly 201 by application of one or more beads 209 of weld material.

The base 204 has a pipe flange engaging structure 210 and a support surface engaging structure 212 attached to the pipe flange engaging structure 210. As depicted, the pipe flange engaging structure 210 includes spaced apart elongated beams 214 and the base engaging structure 208 includes an elongated beam 216. The spaced apart elongated beams 214 define a channel 218 therebetween. The elongated beam 216 of the base engaging structure 208 is slideably disposed within the channel 218 of the pipe flange engaging structure 210. In this regard, the pipe flange engaging structure 210 is translatably engaged with the base engaging structure 208 for allowing a distance between the support surface engaging structure 212 and the pipe engaging structure 206 to be selectively adjusted.

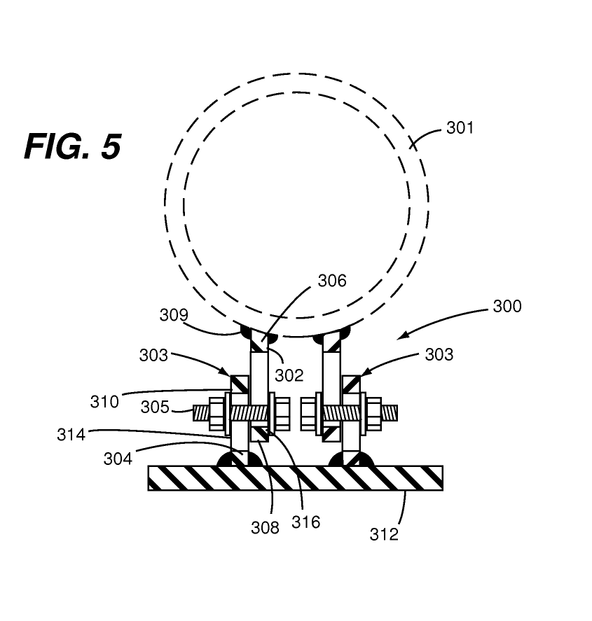

FIG. 5 shows a support apparatus 300 configured in accordance with a third embodiment of the present invention. The support apparatus 300 is used for supporting a structural assembly 301. The support apparatus 300 is similar in construction to the support apparatus 200 discussed above, except with the following noted differences with respect to the support apparatus 200. The support apparatus 300 spaced apart pipe flanges 302 and a base 304. Each pipe flange 302 has a pipe engaging structure 306 and a base engaging structure 308 attached to pipe engaging structure 306. As will be discussed below in greater detail, the pipe engaging structures 306 (and thus the pipe flange 302) can be configured for being welded to the structural assembly 301 by application of one or more beads 309 of weld material.

The base 304 has spaced apart pipe flange engaging structures 310 and a support surface engaging structure 312 attached to the pipe flange engaging structures 310. As depicted, the pipe flange engaging structures 310 each includes an elongated beam 314 and the base engaging structures 308 each include an elongated beam 316. Each elongated beam 316 of the pipe flange 302 is secured to a mating elongated beam 314 of the base 304 (e.g., via a plurality of threaded fasteners 305). In this regard, the pipe flange engaging structure 310 is translatably engaged with the base engaging structure 308 for allowing a distance between the support surface engaging structure 312 and the pipe engaging structures 306 to be selectively adjusted.

Turning now to use of a support apparatus configured in accordance with the present invention, installation of such a support apparatus is a simple procedure. A metal thickness and composition of an elongated structure (e.g., a metal pipe) used in a specified chemical (i.e., use) process is determined. Thereafter, a support apparatus configured in accordance with the present invention is selected according to specific characteristics of the chemical process. Examples of such specific characteristics include, but are not limited to, temperature of process, type of process, specific gravity of materials processed (for weight and flow characteristics) pressure within process, and the like. After the specific characteristics of the chemical process have been determined, the type of material and thickness of the elongated structure and support apparatus can be assessed and selected with respect to requirements (e.g., stress levels) resulting from the chemical process.

If the chemical process permits, the elongated structure and support apparatus can be constructed from a suitable material such as carbon steel that is relatively inexpensive and easy to fabricate. However, if the process requires, the elongated structure and the portion of the support apparatus engaged with the elongated structure (e.g., the entire pipe flange or the pipe engaging structure of the pipe flange) can be constructed from an “exotic material” such as, for example, killed steel, pickled steel, stainless steel, titanium, Inconel, etc. Such an exotic material is defined herein to be a material that is relatively expensive compared to a material such as mild carbon steel. In this regard, a support apparatus configured in accordance with the present invention advantageously allows for only the portion of the support apparatus engaged with the elongated structure needs to be constructed from the exotic material. The base can be made from a less expensive material such as carbon steel (i.e., a standard material), thereby reducing the cost of the base. Furthermore, exotic materials generally require welding processes and filler materials that are not compatible with other lesser expensive materials, thereby requiring more specialized fabrication techniques (e.g., welding) compared to a material such as carbon steel in order to achieve suitable post welded performance (e.g., strength, durability, corrosion resistance, thermal expansion, and the like). Thus, a pipe flange of a support apparatus configured in accordance with the present invention can advantageously be made from the same or suitable material that is weldably compatible with an elongated structure with which it is to be used.

Still discussing use of a support apparatus configured in accordance with the present invention, after of before the appropriate support apparatus is chosen, all or a portion of an elongated assembly comprising a plurality of lengths of the elongated structures is installed. A pipe engaging portion of the pipe flange of the support apparatus is welded to a mating portion (e.g., the bottom, top or side) of the elongated structure. The base of the support apparatus (i.e., pre-constructed bottom of the support apparatus) is then engaged with the pipe flange of the support apparatus. The base is then secured to the pipe flange using a plurality of threaded fasteners each engaged within a respective one of a plurality of sets of aligned passages extending through a base engaging structure of the pipe flange and a pipe flange engaging structure of the base. The base is then field adjusted with respect to the pipe flange to accommodate process requirements, to give the correct slope and height necessary for bringing a support surface engaging portion of the base into uniform (e.g., flat) contact with a suitable support structure surface (e.g., an underlying support surface such as the ground or a floor).

As disclosed above, the pipe flange can be welded to a side or top of the elongated structure. When the pipe flange is welded to the side or top of the elongated structure, the base is brought into contact with a mating support structure (e.g., a sidewall, overhead support, or the like).

In some embodiments, field adjustment of the base entails loosening the threaded fasteners, allowing gravity to bring the base into contact with an underlying support surface and then tightening the threaded fasteners. Once the support apparatus is field adjusted, the threaded fasteners are tightened for causing a base engaging structure of the pipe flange to become urged into contact with a pipe flange engaging structure of the base, thereby inhibiting translation of the pipe flange with respect to the base.

It is disclosed herein that, alternatively, the mechanical fastening arrangement can be omitted and the base can be welded to the pipe flange after field adjustment. If is also disclosed herein that the passages of the base and/or pipe flange can be specifically configured for enabling slope adjustment (e.g., opposing oppositely curved slots with a round passage (i.e., pivot axis) located midway between the curved slots).

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. A support apparatus for an elongated structure, comprising:
a pipe flange having a pipe engaging structure and a base engaging structure attached to pipe engaging structure; and
a base having a pipe flange engaging structure and a support surface engaging structure attached to the pipe flange engaging structure, wherein the pipe flange engaging structure is translatably engaged with the base engaging structure for allowing a distance between the support surface engaging structure and the pipe engaging structure to be selectively adjustable.

2. The support apparatus of claim 1, further comprising:
a mechanical fastening arrangement provided jointly between the base engaging structure and the pipe flange engaging structure, wherein the mechanical fastening arrangement enables translation of the pipe flange with respect to the base to be selectively inhibited.

3. The support apparatus of claim 2 wherein:
the mechanical fastening arrangement includes a first plurality of passages extending through the base engaging structure and a second plurality of passages extending through the pipe flange engaging structure;
two or more of the passages of said first plurality of passages are each aligned with a respective passage of said second plurality of passages thereby defining a plurality of sets of aligned passages;
at least one of the passages of each one of the sets of aligned passages is a slotted passage; and
a threaded fastener engaged within said two or more of the passages of said first plurality of passages that are each aligned with the respective passage of said second plurality of passages for enabling translation of the pipe flange engaging structure with respect to the base engaging structure to be selectively inhibited through tightening of the threaded fastener for causing the base engaging structure to become urged into contact with the pipe flange engaging structure.

4. The support apparatus of claim 3 wherein:
one of the base engaging structure and the pipe flange engaging structure includes an elongated beam and the other one of the base engaging structure and the pipe flange engaging structure includes spaced apart elongated beams defining a channel therebetween; and
the elongated beam is slideably disposed within the channel defined by said spaced apart elongated beams.

5. The support apparatus of claim 1 wherein:
the pipe engaging structure is made from a metal having a first material composition; and
the pipe flange engaging structure and the support surface engaging structure are each made from a metal having a second material composition different than the first material composition.

6. The support apparatus of claim 6 wherein the metal having the first material composition is selected from a group of materials consisting of: killed steel material, pickled steel material, stainless steel material, titanium alloy material, and Inconel alloy material.

7. The support apparatus of claim 5 wherein:
the pipe engaging structure is made from a metallic material having a composition that is weldably compatible with the metallic material having the particular material composition; and
the pipe flange engaging structure and the support surface engaging structure are each made from a metallic material having a composition that is weldably incompatible with the metallic material having the particular material composition.

8. The support apparatus of claim 1 wherein:
one of the base engaging structure and the pipe flange engaging structure includes an elongated beam and the other one of the base engaging structure and the pipe flange engaging structure includes spaced apart elongated beams defining a channel therebetween; and
the elongated beam is slideably disposed within the channel defined by said spaced apart elongated beams.

9. The support apparatus of claim 8 wherein:
the pipe engaging structure is made from a metal having a first material composition; and
the pipe flange engaging structure and the support surface engaging structure are each made from a metal having a second material composition different than the first material composition.

10. The support apparatus of claim 8 wherein the metal having the first material composition is selected from a group of materials consisting of: killed steel material, pickled steel material, stainless steel material, titanium alloy material, and Inconel alloy material.

11. A support apparatus for an elongated structure, comprising:
a pipe flange having a pipe engaging structure and a base engaging structure attached to the pipe engaging structure, wherein at least a portion of the pipe engaging structure is made from a metal having a first material composition and wherein a first plurality of passages extends through the base engaging structure; and
a base having a pipe flange engaging structure and a support surface engaging structure attached to the pipe flange engaging structure, wherein the pipe flange engaging structure is slideably engaged with the base engaging structure in a manner allowing the pipe flange to translate with respect to the pipe flange engaging structure, wherein a second plurality of passages extends through the pipe flange engaging structure, wherein two or more of the passages of said second plurality of passages are each aligned with a respective passage of said first plurality of passages thereby defining a plurality of sets of aligned passages and wherein the pipe flange engaging structure and the support surface engaging structure are each made from a material having a second material composition different than the first material composition; and
a plurality of threaded fastener each engaged within a respective one of said two or more of the sets of aligned passages for enabling translation of the pipe flange engaging structure with respect to the base engaging structure to be selectively inhibited through tightening of each one of the threaded fasteners for causing the base engaging structure to become urged into contact with the pipe flange engaging structure.

12. The support apparatus of claim 11 wherein:
at least one of the passages of each one of the sets of aligned passages is a slotted passage;
one of the base engaging structure and the pipe flange engaging structure includes an elongated beam and the other one of the base engaging structure and the pipe flange engaging structure includes spaced apart elongated beams defining a channel therebetween; and
the elongated beam is slideably disposed within the channel defined by said spaced apart elongated beams.

13. The support apparatus of claim 12 wherein the metal having the first material composition is selected from a group of materials consisting of: killed steel material, pickled steel material, stainless steel material, titanium alloy material, and Inconel alloy material.

14. A method, comprising:
installing at least a portion of a structural assembly including a plurality of lengths of elongated structures that are connected in an end-to-end fashion, wherein an exterior wall of each one of the elongated structures is made from a metallic material having a first material composition;
providing a support assembly including a base and a pipe flange, wherein the base is translatably engaged with the pipe flange for allowing a distance between the base and the pipe flange to be selectively adjustable, wherein the pipe flange is made from a metallic material having that first material composition and the base is made from a metallic material having a second material composition;
engaging the pipe flange with the exterior wall of a particular one of the elongated structures;
applying at least one bead of weld material between the pipe flange and the exterior wall of the particular one of the elongated structures;
translating the base into contact with a support surface adjacent to the particular one of the elongated structures; and
while the base is in contact with the support surface, fixedly securing the base to the pipe flange for inhibiting translation of the pipe flange with respect to the base such that the distance between the pipe flange with respect to the base is fixed.

15. The method of claim 14 wherein:
fixedly securing the base to the pipe flange includes tightening a mechanical fastening arrangement provided jointly between the pipe flange and the pipe flange engaging structure;
wherein the mechanical fastening arrangement includes a first plurality of passages extending through the base engaging structure and a second plurality of passages extending through the pipe flange engaging structure;
wherein two or more of the passages of said first plurality of passages are each aligned with a respective passage of said second plurality of passages thereby defining a plurality of sets of aligned passages; and
wherein a threaded fastener engaged within said two or more of the sets of aligned passages for enabling translation of the pipe flange engaging structure with respect to the base engaging structure to be selectively inhibited through tightening of the threaded fastener for causing the base engaging structure to become urged into contact with the pipe flange engaging structure.

16. The method of claim 15 wherein:
one of the base engaging structure and the pipe flange engaging structure includes an elongated beam and the other one of the base engaging structure and the pipe flange engaging structure includes spaced apart elongated beams defining a channel therebetween; and
the elongated beam is slideably disposed within the channel defined by said spaced apart elongated beams.

17. The method of claim 16 wherein the material having the first material composition is selected from a group of materials consisting of: killed steel material, pickled steel material, stainless steel material, titanium alloy material, and Inconel alloy material.

18. The method of claim 14 wherein:
one of the base engaging structure and the pipe flange engaging structure includes an elongated beam and the other one of the base engaging structure and the pipe flange engaging structure includes spaced apart elongated beams defining a channel therebetween; and
the elongated beam is slideably disposed within the channel defined by said spaced apart elongated beams.

19. The method of claim 14 wherein the material having the first material composition is selected from a group of materials consisting of: killed steel material, pickled steel material, stainless steel material, titanium alloy material, and Inconel alloy material.

20. The method of claim 19 wherein:
at least one of the passages of each one of the sets of aligned passages is a slotted passage;
one of the base engaging structure and the pipe flange engaging structure includes an elongated beam and the other one of the base engaging structure and the pipe flange engaging structure includes spaced apart elongated beams defining a channel therebetween; and
the elongated beam is slideably disposed within the channel defined by said spaced apart elongated beams.
